(19) United States
(12) Patent Application Publication
(10) Pub. No.: US 2017/0357339 A1
(43) Pub. Date: Dec. 14, 2017

(54) VARIABLE DISPLAY PROPERTIES AS A FUNCTION OF INPUT DEVICE TYPE AND INPUT PARAMETER VALUES

(71) Applicant: Microsoft Technology Licensing, LLC, Redmond, WA (US)

(72) Inventors: Steven Bathiche, Kirkland, WA (US); Flavio Protasio Ribeiro, Bellevue, WA (US); Amir Zyskind, Tel Aviv (IL)

(73) Assignee: Microsoft Technology Licensing, LLC, Redmond, WA (US)

(21) Appl. No.: 15/179,882

(22) Filed: Jun. 10, 2016

(51) Int. Cl. G06F 3/0354; G06F 3/038; G06T 11/20; G06F 3/0484; G06F 3/0488

(52) U.S. Cl. CPC G06F 3/03545; G06F 3/038; G06T 11/203; G06F 3/0488; G06F 3/04842

(57) ABSTRACT

A method and system for providing values of display properties as a function of input device type and input parameter values is disclosed. In an implementation, a computer device that receives input entry from an input device, may receive a selection of a mode for the input device corresponding to a writing/drawing device type, and then determine a transfer function based on the mode. The mode may define a type such as pencil, pen, air brush, or other type of drawing device. The transfer function may define at least one display property, such as an inking property, relative to an input parameter such as input device pressure, height, velocity or angle. Input parameter values associated with an input entry may be received and display of the input entry may be initiated using values for the display property based on the transfer function and the input parameter values.

### BACKGROUND

Computer based devices that allow a user to perform writing or drawing input on an input screen with an input device and display the input have increased in number and extent of use in recent years. Typically, these devices allow a user to utilize a stylus, for example, a pen type input device modeled on a real world pen, to perform the writing or drawing input. In use of these computer based devices, it may be advantageous to provide an experience that mimics or emulates aspects of the experience provided to a user when using real world writing or drawing devices. Providing this experience would allow the user of a computer based device an intuitive experience and flexibility in creating writing or drawing.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments of methods and systems for providing variable display properties as a function of input parameter values associated with writing or drawing input entry to a computer device using an input device, where the function is based on a mode selected for the input device, are disclosed. In one implementation, a computer device that receives input entry performed using an input device may determine a mode for the input device, where the mode corresponds to a type of writing/drawing device, and then determine a transfer function based on the mode for the input device. The transfer function may define at least one display property relative to an input parameter associated with the input device. The transfer function may be a non-linear function. Values of the input parameter as associated with input entry as a user writes/draws with the input device may be provided to the computer device. Values for the display property may be determined based the values of the input parameter and the transfer function. The values for the display property may then be used in displaying the writing/drawing input entry, or may be stored for use in later display of the input entry.

An example computer device may be implemented in a device having a touch sensitive screen configured to receive writing or drawing input entry. The computer device may be configured to receive the writing or drawing input entry from a user applying an input device to the touch sensitive screen. The input device may be configured as an active touch sensitive input device, such as a pen or a stylus type device configured to communicate an input parameter comprising pressure values of the force with which the input device is applied to the touch sensitive screen on the computer device. The computer device may also include transfer functions stored in memory where each transfer function is associated with a mode defining a writing/drawing device type for the input device. The transfer functions may include functions that define an inking display property of brush width, i.e., line size, for the touch sensitive screen as a non-linear function of the input parameter of pressure of application of the input device to the touch sensitive screen. In alternative implementations, other display properties such as opacity, angle, roundness or flow, wetness, scattering, or blending of writing or drawing lines may be used. Also, in further alternative implementations, other input parameters such as tilt angle, twist angle, velocity, acceleration, hover height, time windowed displacement, or any other indicator of input device dynamics may also be used as the display parameter. Use of the non-linear functions allow a user to make selections of inking display properties for the input device that emulate one or more real physical writing/drawing devices as the physical devices would react to the pressure with which they are applied to a surface. For example, a non-linear function emulating the inking behavior of each of a pencil, pen, paint brush, airbrush or other physical input device as application pressure changes may be selected by selection of an appropriate mode. As writing/drawing input entry is received, the pressure sensitive input device sends values of input pressure to the computer device and the computer device determines, based on the received values of input pressure, a value for the inking display property of brush width according to the inking property transfer functions of the selected mode. Display of the writing/drawing input entry may then be initiated using the value for the inking display property, or the value of the inking display property may be stored for use in later display of the writing/drawing input entry.

In an implementation, the computer device may receive a selection from a user selecting a mode to be used for the input device while the actual physical input device may stay the same. That is, the defining of the mode for the input device may be performed in the computer device independently of the input device being used. For example, a stylus used as the input device may be used in various modes selected at a user interface based on a user's needs. In another example implementation, the computer device may receive an indication of a mode for the input device from the input device. The indication may be received from the input device, for example, upon a selection of modes made at the input device by using an input control on the input device. The indication may also be received from the input device when a user changes or installs a physical writing/drawing tip on the input device that defines a mode for the input device. The indication of a mode may also be received by the computer device sensing a type of writing drawing tip installed on the input device when the input device is applied to a touch sensitive screen of the computer device. The computer device determines the mode for the input device from the received user selection or the indication received from the input device and then determines one or more transfer functions for an inking display property as a function of an input parameter based on the determined mode.

### BRIEF DESCRIPTION OF THE DRAWINGS

FIG. 1 is a simplified block diagram of an example system according to an embodiment of the disclosure;

FIG. 2A is a flow diagram illustrating example operations performed by the example computer device of FIG. 1;

FIG. 2B is a flow diagram illustrating example operations performed by an example input device operating with an implementation of the computer device of FIG. 2A;

FIG. 3 is a flow diagram illustrating operations performed by an example computer device and input device;

FIGS. 4A and 4B show functions illustrating size and opacity, respectively, versus pressure for an example pencil mode for an input device;

FIGS. 4C and 4D show functions illustrating size and opacity, respectively, versus pressure for an example ballpoint pen mode for an input device;

FIGS. 4E and 4F show functions illustrating size and opacity, respectively, versus pressure for an example fountain pen mode for an input device;

FIGS. 4G and 4H show functions illustrating size and opacity, respectively, versus pressure for an example felt tip pen mode for an input device;

FIG. 4I shows a function illustrating force versus hover height for an example airbrush mode for an input device;

FIG. 4J shows a function illustrating major axis/minor axis versus tilt angle for an example airbrush mode for an input device;

FIG. 4K shows a function illustrating opacity versus velocity for an example airbrush mode for an input device;

FIG. 5 illustrates examples of the display size of input device types varying with input pressure;

FIG. 6 is a simplified block diagram illustrating an example computer device; and,

FIG. 7 is a simplified block diagram illustrating an example input device.

### DETAILED DESCRIPTION

The system, method and computer device will now be described by use of example embodiments. The example embodiments are presented in this disclosure for illustrative purposes, and not intended to be restrictive or limiting on the scope of the disclosure or the claims presented herein.

The disclosed embodiments provide a technical advantage by allowing input entry, such as writing or drawing input entry performed using an input device on a surface associated with a computer device, to be selectively displayed using display properties that emulate the characteristics of different types of real world writing or drawing devices. The writing or drawing input entry may include any type of input entry performed on the surface, such as text writing, artwork, painting, sketching, or any other type of drawing. The display properties may define characteristics such as the size, opacity, angle, roundness or flow, wetness, scattering, or blending of writing or drawing lines. Use of the display properties allows the computer device to accurately reflect characteristics of different types of real writing or drawing input devices when displaying input entries made using an input device such as a stylus.

In the embodiments, a transfer function may be defined for each of one or more modes of input devices where each of the modes defines a type of writing/drawing device. The modes may define types of writing/drawing devices such as pens, pencils, brushes, paint brushes, airbrushes, or any other type of input device that may be emulated. Each transfer function may be configured to define display characteristics versus values of an input parameter as the value of the input parameter varies during writing or drawing input entry. The input parameter may be, for example, pressure, tilt angle, twist angle, velocity, acceleration, hover height, time windowed displacement, or any other indicator of input device dynamics as the input entry is performed. The transfer functions may be configured as non-linear functions in order to emulate the true display characteristics of real world writing/drawing devices as the input parameter values vary during input. Providing the user of a computer device the flexibility to select easily from the different modes for an input device allows accurate emulation of a variety of writing instruments at the computer device.

For example, a person, who is practiced and skilled at writing and drawing on conventional surfaces such as paper, or another medium, may desire to use a stylus to write or draw as a user of a computer device. In situations such as this, the user may have a finely tuned sense of the characteristics of certain writing instruments and a sense of how to apply these writing instruments on paper, or other medium. For example, the user may be skilled at using variations in the parameters of pressure, angle, or other writing or drawing dynamics when using different writing instruments to achieve a desired effect. If the user attempts to write or draw using a conventional computer device, the user may not be able to achieve a desired effect because they are not provided flexibility in being able to choose easily from different modes that allow accurate emulation of a variety of writing instruments at the computer device. They also may not achieve a desired effect using a conventional computer device because the computer device will not have the capability to translate the users writing/drawing entry performed at the computer device as the user intends. For example, the user may intend certain nuanced variations in pressure, angle, and other writing or drawing dynamics to be interpreted by the computer device as if the stylus is a lead pencil or ink pen and the surface to which the stylus is applied is paper or other medium. In this situation a conventional computer device will not be capable of accurately interpreting the writing or drawing dynamics to reflect the user's intention in the display of the writing/drawing entry. Use of the embodiments provide a computer device that is capable of allowing a user flexibility in being able to choose easily from different modes that allow accurate emulation of a variety of writing instruments at the computer device. Use of the embodiments also provides a computer device having the capability to interpret the user's writing/drawing entry performed at the computer device with a stylus while using intentional variations in pressure, angle, and other writing or drawing dynamics. Use of the embodiments allows these variations in input parameters to be interpreted and displayed/printed by the computer device as if the writing /drawing were performed on a conventional medium such as paper using an actual writing instrument such as a lead pencil or pen.

Use of the modes also provides advantages in that the mode may be defined at any level of detail that reflects differences in writing/drawing devices. For example, modes may be defined and associated with a transfer function for different types of pencils with different lead hardness or lead sizes, or pens with different types of tip/ball point sizes or tip/ball point characteristics, or different airbrush configurations. Allowing use of different modes associated with different transfer functions allows the different non-linear behavior of different real world drawing and writing devices to be realistically emulated.

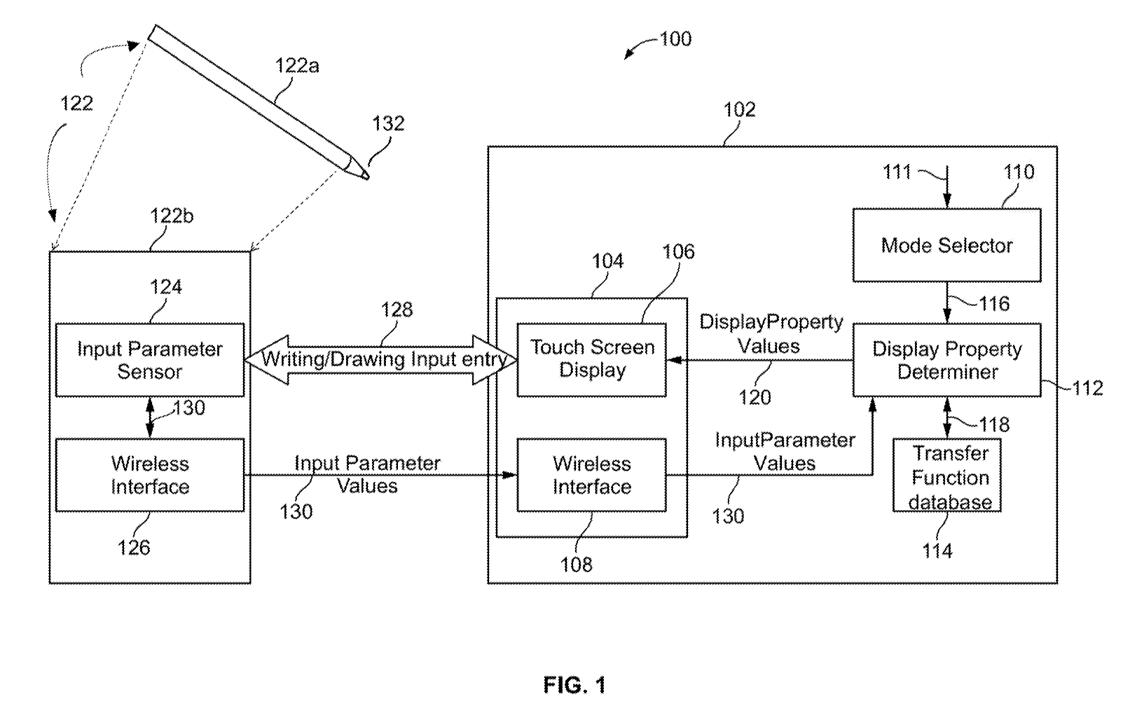

Referring now to FIG. 1, therein is a simplified block diagram of an example system 100 according to an embodiment of the disclosure. FIG. 1 shows system 100 as including computer device 102 and input device 122. Computer device 102 may include touch screen unit 104 comprising touch screen display 106 and wireless interface 108. Wireless interface 108 may be, for example, an electromagnetic or active capacitance digitizer interface implemented within touch screen display 106. Computer device 102 also includes mode selector 110, display property determiner 112, and transfer function database 114. Input device 122 is shown as comprising casing 122a that inclndes writing/drawing tip 132 and internal components 122b that include input parameter sensor 124 and wireless interface 126. In the example of FIG. 1, input parameter sensor 124 and wireless interface 126 may be configured within casing 122a. Wireless interface 126 may be configured to communicate with wireless interface 108 of computer device 102 as input device 122 is applied to touch screen display 106 while performing writing/drawing input entry 128. Computer device 102 and input device 122 of FIG. 1 may be implemented in any appropriate configuration of hardware and software.

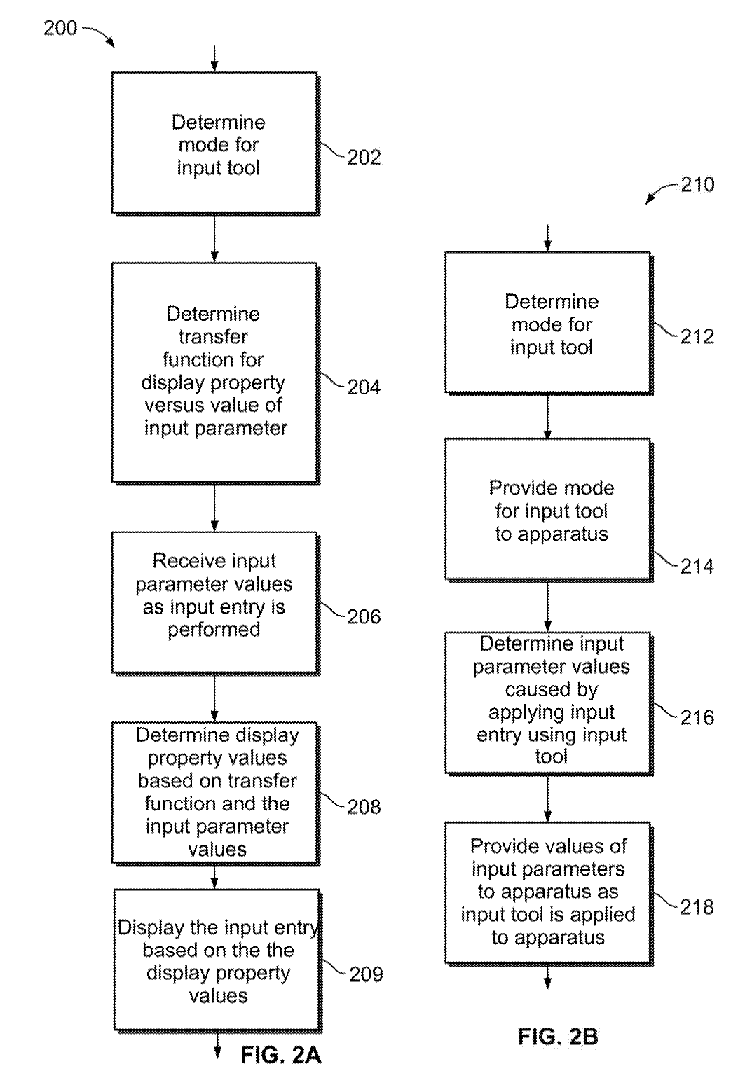

Operation of system 100 of FIG. 1 may be described with reference to FIG. 2A. FIG. 2A shows a flow diagram 200 that illustrates example operations performed in system 100. In one example implementation, the operations of FIG. 2A may be performed by a computer device such as computer device 102 of FIG. 1 when receiving writing or drawing input entry 128 made on touch screen display 106 using input device 122.

The process begins at 202 where the mode selector 110 determines a mode corresponding to a type of writing/drawing device based on a received mode selection 111. Mode selector 110 then provides an indication of mode selection 116 to display property determiner 112. The mode 116 may be associated with a type of writing/drawing device to be imitated by the input device 122, such as a pencil, pen, paint brush, airbrush or other physical input device. In one implementation, the mode selector 110 comprises an application program on computer device 102; the mode selector 110 may determine the mode for the input device by receiving an indication of the mode selection 111 from a user interface at touch screen display 106. In this implementation, the user interface may provide a user options from which to select the mode. In alternative implementations, the mode selector 110 may be implemented on the input device 122 and display property determiner 112 may receive the indication of the mode selection 116 from a user selection made at an interface or selection switch on the input device 122. In this implementation input device 122 may provide the indication of the mode selection 116 to display property determiner 112 through wireless interfaces 126 and 108, or another communication interface between input device 122 and computer device 102.

At 204 display property determiner 112 determines a transfer function for a display property relative to an input parameter based on the mode selection 116. The transfer function may define a display property relative to an input parameter based on the mode for the input device determined at 202. Display property determiner 112 may determine the transfer function by retrieving the transfer function 118 from transfer function database 114. In alternative implementations, display property determiner 112 may retrieve the transfer function from a remote network or cloud database. The transfer function may then be stored on computer device 102 in transfer function database 114. In another implementation the transfer function may be received from input device 122 and stored in transfer function database 114. The transfer function may be non-linear. In various implementations the display property defined by the transfer function may include the size, opacity, angle, roundness or flow, wetness, scattering or blending of writing or drawing lines. The input parameter may be, for example, pressure, tilt angle, twist angle, velocity, acceleration, hover height, time windowed displacement, or any other indicator of input device dynamics as the input entry is performed. Display property values may include particular values of a display property. For example, the display property values may include a particular value of a line width. Input parameter values may comprise particular values of an input parameter. For example, an input parameter value may be a particular amount or measurement of pressure

At 206 display property determiner 112 receives input parameter values 130 as writing/drawing input entry 128 is performed using input device 122. The input entry may be performed by a user holding casing 122a and writing or drawing by applying witing/drawing tip 132 to touch screen display 106. Input parameter sensor 124 of input device 122 may be configured to sense the input parameter values as input device 122 is applied to touch screen display 106 and provide the input parameter values 130 to wireless interface 126 for communication to wireless interface 108. Display property determiner 112 may receive the input parameter values 130 through wireless interface 108. For example, input parameter sensor 124 may measure the amount of pressure as writing/drawing input entry 128 is performed using input device 122 and provide the amount of pressure to wireless interface 126 for communication to the wireless interface 108. Wireless interface 108 may then provide the amount of pressure as input parameter values 130 to display property determiner 112. In alternative implementations using other than pressure as input parameter values, the values of the input parameters 130 may be determined at computer device 102 by a processing unit that processes writing/drawing input entry 128 applied at touch screen display 106. The determination of input parameter values at computer device 102 may be useful when input device 122 is not capable of measuring or determining the values of a particular input parameter. Display property determiner 112 may then receive the values of the input parameters 130 determined within device 102 from the processing unit.

At 208 the display property determiner 112 determines display property values 120 based on the transfer function 118 and the input parameter values 130 received from the input device 122. Display property determiner may then provide the display property values 120 to touch screen display 106.

At 209 computer device 102 may display the writing/drawing input entry 128 on touch screen display 106 according to the display property vaues 120. Thus, based on the mode 116 selected, the inking displayed on the touch screen display 106 will appear to have been entered by a desired device rather than by a generic stylus. In one configuration, the writing/drawing input entry 128 may be stored in the computer device for later display using the determined display characteristics.

While FIG. 2A was described in relation to operations performed by a computer device configured to receive writing or drawing input performed using an input device, embodiments of FIG. 2A also include any other implementations in which the described operations are performed. For example, in one alternative implementation, operations 202-208 of FIG. 2A may be performed by an input device and the value of the display characteristic determined at 208 may be sent to the computer device as writing or drawing input takes place. In another example implementation, the operations of FIG. 2A may be distributed between each of the computer device and the input device in any other appropriate manner.

Implementations of FIG. 2A may include simultaneous use of more than one display property. For example, implementations may include using operation 204 to determine two or more transfer functions for a determined input device mode. For example, a first and second transfer function for the display properties of size and opacity, respectively, versus input parameter values such as values of pressure may be determined by using operation 204 to determine each transfer function based on the input device mode. When values for input pressure are received at 206, display property values of both size and opacity may then be determined from the first and second transfer function, respectively, by using operation 208. The display property values may then be used simultaneously in displaying writing or drawing input entries where the display shows both size and opacity as affected by input pressure value.

Implementations of FIG. 2A also may include simultaneous use of more than one type of input parameter value. For example, implementations may include using operation 204 to determine two or more transfer functions for a determined input device mode. For example, a first and second transfer function for input parameter values of pressure and device angle, respectively, versus a display property may be determined by using operation 204 to determine each transfer function based on the input device mode. Input pressure and angle measurement values may be received by using operation 206 to receive each value. Display property values for each of the pressure and angle values may then be determined from the first and second transfer function, respectively, by using operation 208. The display property values may then be used simultaneously in displaying writing or drawing input entry where the display shows the display property as affected by both input pressure and input device angle values.

Referring now to FIG. 2B, therein is a flow diagram 210 illustrating example operations performed by an example input device operating with an implementation of the computer device of FIG. 2A. FIG. 2B illustrates an example implementation in which the mode for the input device is determined at the input device and may be described with reference to FIG. 1. In this implementation mode selector 110 may be configured on input device 122.

The process begins at 212 where input device 122 determines a mode corresponding to a type of writing/drawing device. In the example implementation of FIG. 2B, a user of input device 122 may select the mode at a control input of input device 122 and input device 122 may determine the mode selection by receiving the indication of mode selection 111 from the user at mode selector 110. This may be performed by setting a selection switch, button, or other input at a user interface on casing 122a of input device 122 to select the mode for input device 122, or communicating a wireless signal to input device 122 where the wireless signal includes control information that is used to configure the input device for a particular mode. In another implementation, input device 122 may be configured so that a user may place different interchangeable writing tips on input device 122 to select modes. For example, if input device 122 is configured as a pen or stylus type device, input device 122 may be configured to be equipped with different writing/drawing tips 132 having different modes. In this implementation input device 122 may determine the mode by detecting the type of tip with which it is equipped. The detection may be performed by input device 122 sensing the mode of the tip through mechanical or wireless sensing, or other circuitry of the input device sensing the tip characteristics. In an alternative implementation of operation 212, a single input device such as input device 122 may have a set mode that doesn't change. For example, the mode for input device 122 may be determined at the manufacturing stage. In this implementation, a user may change input device modes by switching to an input device configured with the desired mode and configured to provide an indication of that mode to the computer device 102. Multiple input devices may be configured as a set, for example a set of pens or styluses that are each associated with a different mode type. In one example, the physical characteristics of each input device of the set may be configured to be representative of the mode of that input device.

At 214 the input device provides an indication of the mode selected for the input device to computer device 102. In the implementation of FIG. 2B mode selector 110 may provide the mode 116 to display property determiner 112 through wireless interfaces 126 and 108, or another communication interface between input device 122 and computer device 102. In other implementations, the indication of the mode may be provided to the computer device 102 by communicating the indication through a short range interface such as Bluetooth. In an alternative implementation of operations 212 and 214 using different writing/drawing tips 132, the mode of the tip 132 may be sensed directly by computer device 102 without the input device 122 needing to be involved in determining the mode. For example, the mode of the tip 132 may be sensed at touch screen display 106 and provided to display property deteminer 112 through wireless interface 108 when input device 122 is applied to touch screen display 106.

Next at 216, input parameter sensor 124 of input device 122 determines input parameter values caused by using input device 122 to input writing/drawing input entry 128 to touch screen 104 and, at 218, input parameter sensor 124 provides the input parameter values to display property determiner 112 of computer device 102 through wireless interfaces 126 and 108. These may be the input parameter values received by the computer device at operation 206 of FIG. 2A.

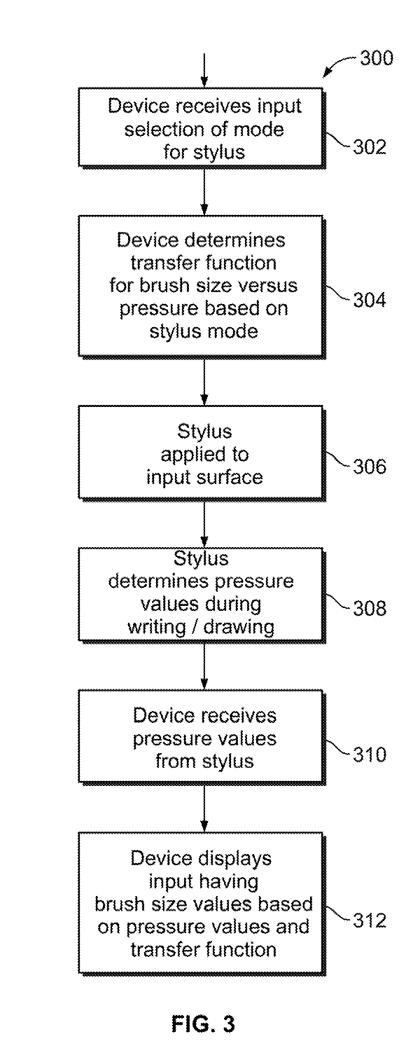

Referring now to FIG. 3, therein is a flow diagram 300 illustrating operations performed by an example computer device and writing/drawing stylus. The computer device may be configured as an implementation of the computer device 102 and the stylus may be configured as an implementation of the input device 122 as shown in FIG. 1. In the description of the process of FIG. 3, computer device 102 will be referred to as computer device 102 and input device 122 may be referred to as stylus 122. The computer device 102 may interact with the stylus 122 to perform the operations of FIG. 3, FIG. 3 illustrates an implementation in which the mode for the stylus 122 is determined at the computer device 102. In the implementation of FIG. 3, the display property is the inking property of input device brush size, for example writing or drawing linewidth, and the input parameter is pressure with which the input is used to input drawing/writing entry on touch screen display 106.

In the implementation, the computer device 102 may be implemented, for example, as a tablet type device that includes touch screen unit 104. Stylus 122 may have the shape and appearance of a pen such as shown by casing 122a of FIG. 1. The computer device 102 and stylus 122 may be configured to communicate with each other, for example, through electromagnetic or active capacitance digitizer interfaces 126 and 108 implemented in the touch screen unit 104 and stylus 122. Stylus 122 may be a pressure sensitive stylus configured to provide values of stylus pressure values 130 on the touch screen display 106 during writing/drawing input entry 128, as measured by input parameter sensor 124, to the display property determiner 112 of computer device 102 through interfaces 126 and 108.

The process begins at 302 where mode selector 110 receives an input selection 111 of a mode for the stylus 102. The selection may be received, for example, as input from a user of computer device 102 performed at a user interface of a drawing or writing application program displayed on touch screen display 106 on computer device 102. Mode selector 110 then provides an indication of the mode 116 to display property determiner 112. In an example implementation the application may provide the user with a menu of mode selection choices from which to choose. For example, the menu may present selections such as modes for pencil, ballpoint pen, fountain pen, paint brush, felt tip pen, or air brush from which the user may select. The modes may be defined to allow selection of a mode for the stylus at a desired level of specificity, for example, pencil modes for various lead sizes and lead hardness, or combinations of lead sizes and lead hardness, may be selected. The modes may also be defined to allow selection of modes for the stylus having detailed characteristics such as ink type, tip size, ink flow and other characteristics for ballpoint, fountain or felt tip pen types. Default values may be used for a particular characteristic if the mode selection does not allow the characteristic to be chosen.

At 304 display property determiner 112 determines a transfer function for the display property of brush size versus the input parameter of pressure based on the selected stylus mode 116. In the implementation, brush size refers to size or width of any displayed writing or drawing line received from stylus 122 in any selected mode. The device may retrieve the transfer function118 from transfer function database 114 that includes transfer functions for the brush size versus pressure for each of the selectable modes for the stylus. The transfer functions may be non-linear and configured to model the real world characteristics of a writingsdrawing device having the physical characteristics defined by each of the selectable modes for the stylus.

At 306 the user applies stylus 102 to touch screen display 106 and begins writing or drawing. At 308, as the user writes or draws (performing writing/drawing input entry 128), input parameter sensor 124 in the stylus 122 reports the values of pressure to the display property determiner 112 through wireless interfaces 126 and 108.

At 310 display property determiner 112 receives the pressure values 130 from stylus 122 and provides the display property values 120 to touch screen display 106. At 312, the writing/drawing input entry 128 is displayed on touch screen display 106 as the user writes or draws. The writing/drawing input entry 128 is displayed with the brush size applied based on the pressure values 130 received from stylus 122 and according to the function determined at 304 for the display property of brush size versus the input parameter of pressure.

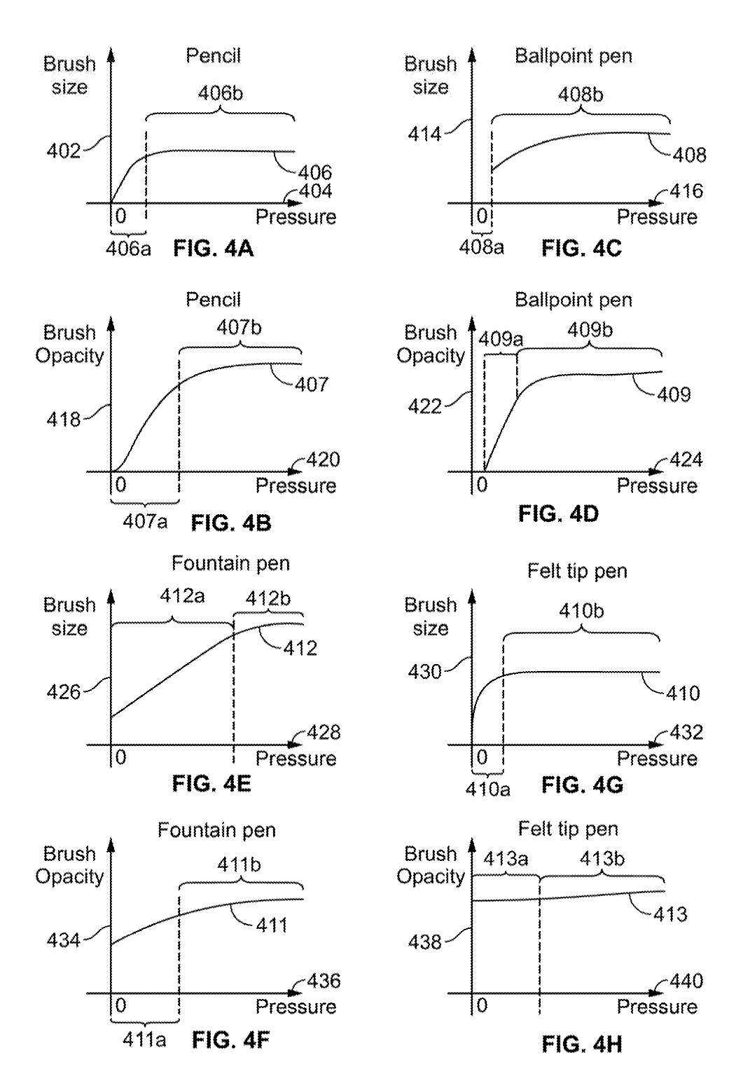

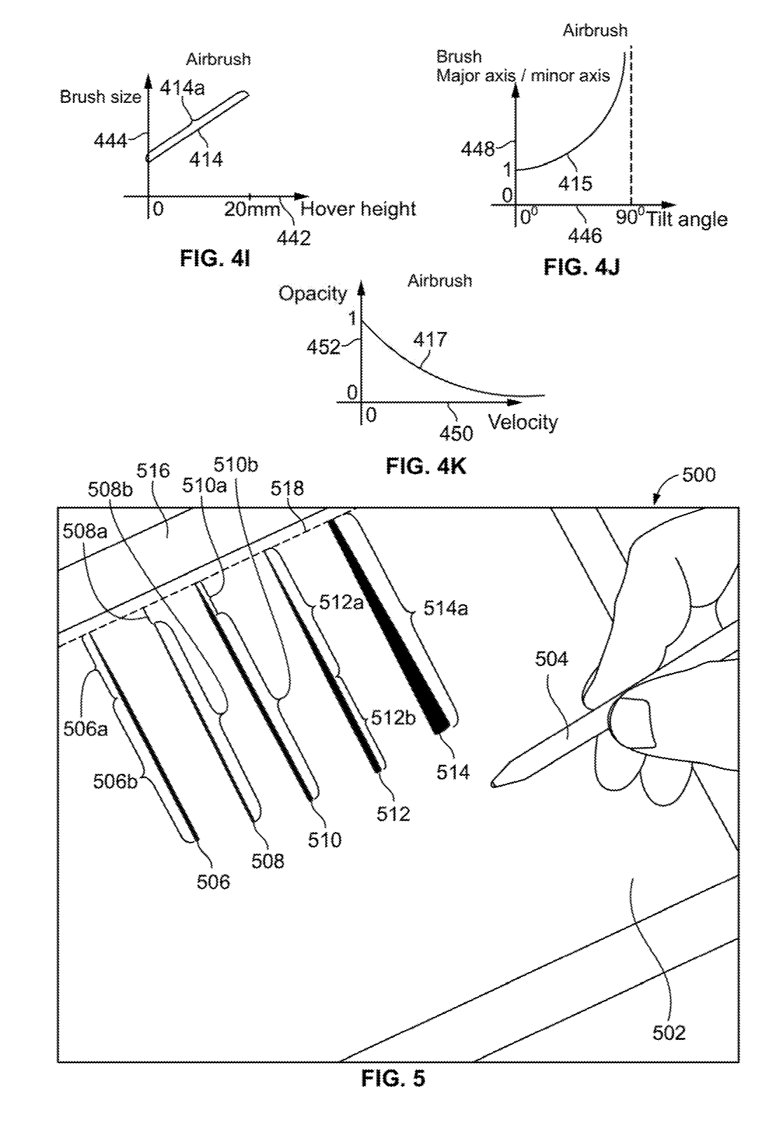

FIGS. 4A-4H show example transfer functions of the display properties of brush size and brush opacity versus input parameter values of the input parameter of pressure for different modes of an input device. The transfer functions of FIG. 4A-4H show examples that may be used in various implementations of the embodiments. The vertical axis in each figure represents the value of either brush size or opacity versus a value of pressure that is shown along the horizontal axis. The values increase along each axis in the direction of the arrow. FIG. 4A-4H illustrate the advantages provided by the embodiments in allowing selection of modes for an input device where each mode is associated with a different non-linear transfer function.

FIGS. 4A and 4B show functions illustrating brush size and opacity, respectively, versus pressure for an example pencil mode for an input device. FIG. 4A illustrates that as pressure increases from a value of 0 along axis 404 the brush size also increases in a non-linear manner on axis 402. Brush size increases relatively quickly along portion 406a of function 406 as pressure increases and then substantially levels out along portion 406b of the function 406 for further increases in pressure. FIG. 4B illustrates that as pressure increases from a value of 0 along the axis 420 the brush opacity also increases in a non-linear manner on axis 418. Brush opacity increases with a relatively steady slope along portion 407a of the function 407 as pressure increases and then substantially levels out along portion 407b for further increases in pressure.

FIGS. 4C and 4D show functions illustrating brush size and opacity, respectively, versus pressure for an example ballpoint pen mode for an input device. FIG. 4C illustrates that as pressure increases from a value of 0 along the axis 416 the brush size also increases in a non-linear manner on axis 414. FIG. 4C also illustrates a non-linear characteristic of ball point pens that use of the embodiments allows to be emulated using a device such as the computer device 102 of FIG. 1. FIG. 4C shows portion 408a of the function 408 where the brush size is 0, i.e., no writing or drawing lines are displayed, until the pressure reaches a threshold level at the end of portion 408a. Then as pressure increases the brush size increases through portion 408b until the increase levels off. Use of the transfer function of 4C allows devices and input devices to emulate this type of behavior where a ballpoint pen tip may require that the pen be applied to a surface with a certain level of pressure before ink begins to flow from the pen. FIG. 4D illustrates that as pressure increases from a value of 0 along the axis 424 the brush opacity also increases in a non-linear manner on axis 422. Once the threshold value of pressure is reached on axis 424, brush opacity increases with a relatively steady slope along portion 409a as pressure increases and then substantially levels out along portion 409b for further increases in pressure.

FIGS. 4E and 4F show functions illustrating brush size and opacity, respectively, versus pressure for an example fountain pen mode for an input device. FIG. 4E illustrates that as pressure increases from a value of 0 along axis 428 the brush size also increases in a non-linear manner on axis 426. Brush size increases along portion 412a of the function 412 as pressure increases and then substantially levels out along portion 412b for further increases in pressure. FIG. 4F illustrates that as pressure increases from a value of 0 along the axis 436, the brush opacity also increases in a non-linear manner on axis 434. Brush opacity increases with a relatively steady slope along portion 411a of the function 411 as pressure increases and then the slope reduces along portion 411b tor further increases in pressure.

FIGS. 4G and 4H show functions illustrating brush size and opacity versus pressure, respectively, for an example felt tip pen mode for an input device. FIG. 4G illustrates that as pressure increases from a value of 0 along the axis 432 the brush size also increases in a non-linear manner on axis 430. Brush size increases relatively quickly along portion 410a of the function 410 as pressure increases and then substantially levels out along portion 410b for further increases in pressure. FIG. 4H illustrates that as pressure increases from a value of 0 along the axis 440, the brush opacity also increases in a non-linear manner on axis 438. Brush opacity increases with a relatively steady slight slope along portion 413a of function 413 as pressure increases and then continues with a slightly different slope along portion 413b for further increases in pressure.

Multiple functions may also be created for each of the modes of input devices shown in FIGS. 4A-4H. For example, variations of the function of FIG. 4A may be generated for pencils having lead with different hardness and sizes, or variations of the function of FIG. 4C may be generated for pens with, for example, different ballpoint pen tip pressure characteristics fir activation of ink flow, ball point pen tip sizes, or pen ink characteristics.

FIGS. 4A-4H illustrate the behavior and the differences between the behaviors of different modes of input devices such as pens, pencils, or other input devices. Use of the embodiments having different selectable modes for input devices where the modes are associated with nonlinear functions, such as those shown in FIGS. 4A-4H, allows a user to configure the appearance of displayed writing or drawing input entry to the user's needs.

FIG. 4I-4K illustrate example functions that may be utilized in implementations of the embodiments having an airbrush mode for an input device. FIG. 4I shows brush size versus hover height for an example airbrush mode for an input device. As hover height increases from 0 mm to 20 mm along the horizontal axis 442, brush size increases from an initial value on the vertical axis 444 along portion 414a of function 414. The brush size then falls to 0 as the airbrush becomes too far away from the surface at a hover height of 20 mm. FIG. 4J shows a function illustrating; major axis/minor axis ratio versus tilt angle for an example airbrush mode for an input device. The major axis/minor axis ratio shown along axis 448 represents the aspect ratio (longest axis length to shortest axis length) of an image made by the input device in airbrush mode. The function 415 shows that as the tilt angle of the input device changes from 0 to 90 degrees along axis 446, the major axis of the image becomes much larger than the minor axis. FIG. 4K shows a function illustrating opacity versus velocity for an example airbrush mode for an input device. In FIG. 4K, as velocity on the input device increases from 0 along horizontal axis 450, the function shown by line 417 indicates the opacity of the drawing or writing performed by the input device decreases non-linearly from 1 to near 0 on the vertical axis 452.

Reference is now made to FIG. 5, which illustrates examples of displayed brush size of modes for input devices varying with input pressure. FIG. 5 shows a portion of an example device 500 having a touch screen 502. Input device 504 is shown as an example stylus or pen type device configured to provide values of pressure to device 500 indicating the pressure with which input device 504 is applied to touch screen 502 for providing writing/drawing input entry. Device 500 and input device 504 may be configured as computer device 102 and stylus 122 as described above in relation to FIG. 3.

In FIG. 5. line 506 illustrates an example line that may be drawn when a pencil mode having the transfer function of FIG. 4A is selected for input device 504. Line 506 may be drawn starting at dotted line 518. In the example of line 506, a user may apply a pressure with input device 504 that increases substantially steadily as the line is drawn. With reference to FIG. 4A, when the pressure applied by the user increases through portion 406a of function 406 of FIG. 4A, the width of line 506 in FIG. 5 increases as it is drawn, which is illustrated by portion 506a of line 506. When the pressure applied by the user increases and reaches portion 406b of function 406 of FIG. 4A, the width of line 506 remains constant as it is drawn, as illustrated by portion 506b of line 506.

In FIG. 5, line 508 illustrates another example line that may be drawn when a ballpoint pen mode having the transfer function of FIG. 4C is selected for input device 504. Input device 504 may be applied to the surface starting at dotted line 518 to draw line 508. In the example of line 508, a user may apply a pressure with input device 504 that increases substantially steadily as the line is drawn. With reference to FIG. 4C, when the force applied by the user increases through portion 408a of function 408 of FIG. 4C as the line is drawn, line 508 does not show on the screen at any width. This is shown in FIG. 5 by portion 508a of line 508. As was described for FIG. 4C, this is because function 408 is configured so that display of ink does not begin until the pressure with which the input device 504 is applied reaches a threshold value at the end of portion 408a. As the user draws and increases the pressure, the pressure reaches the threshold value and the brush width increases according to portion 408b of function 408. This is illustrated by portion 508b of line 506.

In FIG. 5, line 510 illustrates another example line that may be drawn when a felt tip pen mode having the transfer function of FIG. 4G is selected for input device 504. Line 510 may be drawn starting at dotted line 518. In the example of line 510, a user may apply a pressure with input device 504 that increases substantially at the same rate as the line is drawn. With reference to FIG. 4G, when the pressure applied by the user increases through portion 410a of function 410 of FIG. 4A, the width of line 510 in FIG. 5 increases as it is drawn, as illustrated by portion 510a of line 510. When the force applied by the user increases and reaches portion 410b of function 410 of FIG. 4G, the width of line 510 remains substantially constant as it is drawn, as illustrated by portion 510b of line 510.

Line 512 of FIG. 5 illustrates another example line. Line 512 may be drawn when a fountain pen mode having the transfer function of FIG. 4E is selected for input device 504. Line 512 may be drawn starting at dotted line 518. In the example of line 512, a user may apply a pressure with input device 504 that increases substantially at the same rate as the line is drawn. With reference to FIG. 4E, when the force applied by the user increases through portion 412a of function 412 of FIG. 4E, the width of line 512 in FIG. 5 increases as it is drawn, as illustrated by portion 512a of line 512. When the force applied by the user increases and reaches portion 412b of function 412 of FIG. 4E, the width of line 512 remains substantially constant as it is drawn, as illustrated by portion 512b of line 512.

FIG. 5 also illustrates example line 514 which may be drawn when an airbrush mode having the transfer function of FIG. 4I is selected for input device 504. Line 514 may be drawn starting at dotted line 518. In the example of line 514, a user may start with a hover height of 0 for input device 504 and increase the hover height at a substantially constant rate as the line is drawn. With reference to FIG. 4I, when the hover height increases from 0 to 20 mm through portion 414a of function 414 of FIG. 4I, the width of line 514 in FIG. 5 increases as it is drawn, as illustrated by portion 514a of line 514. When the hover height used by the user reaches 20 mm, line 514 disappears from the display as defined by function 414 of FIG. 4I.

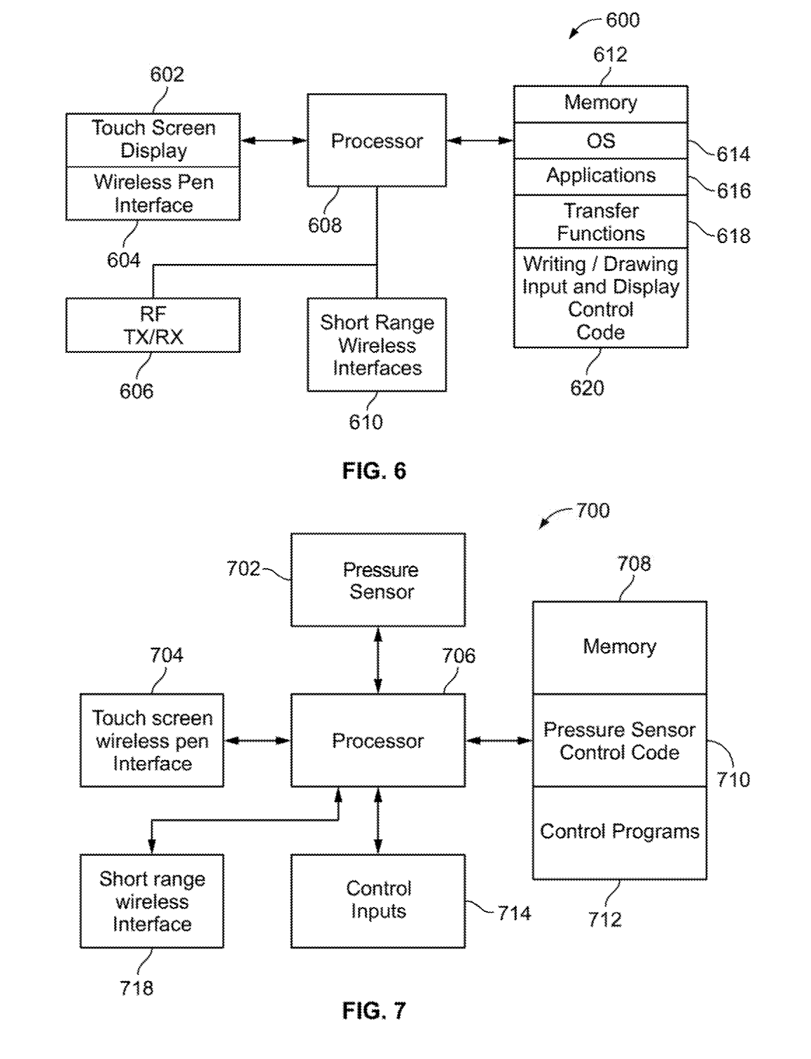

Referring now to FIG. 6, therein is a simplified block diagram illustrating an example computer device 600. Computer device 600 includes touch screen display 602, wireless pen interface 604, RF transceiver (TX/RX) 606, processor 608, short range wireless interfaces 610, and memory 612. Memory 612 includes programs and code for operating system (OS) 614, applications 616, transfer functions 618, and writing/drawing input and display control code 620. Memory 612 may be implemented as any type of computer readable storage media in computer device 600, including non-volatile and volatile memory. Processor 608 may comprise one or more processors, or other control circuitry or any combination of processors and control circuitry. Processor 608 provides overall control of computer device 600 by executing instructions or code in memory 612 to provide necessary functions for operation of computer device 600 according to the disclosed embodiments.

In an example implementation, processor 608 may control computer device 600 to perform operations of FIG. 2A or FIG. 3 by executing the programs and code in memory 612. Writing/drawing input and display application programs 620 may provide overall control for writing or drawing applications when writing/drawing input entry is performed using an input device. OS 614 and applications 616 may operate in interaction with writing/drawing input and display control code 620 to provide functions of computer device 600 used for writing or drawing applications. Transceiver 606 may be used to allow computer device 600 to communicate over a cellular or Wi-Fi network, for example to access data to update or download data associated with transfer functions 618 or update or download writing/drawing input and display control code 620. Short range interfaces 610 may be used to communicate with other devices. For example, in some implementations, depending on the input device, certain communications with the input device may be performed over short range interfaces 610 using protocols such as Bluetooth or Wi-Fi Direct.

In example implementations, computer device 600 may receive a user's selection of a mode for an input device at a user interface on touch screen 602. Processor 608 may then determine an appropriate transfer function for the mode by retrieving transfer function data from transfer functions 618 stored in memory based on the selected mode. A user of computer device 600 may then provide writing drawing input entry at touch screen display 602 using an input device. As the user draws or writes, wireless pen interface 604 receives values of an input parameter such as input pressure from the input device. Wireless pen interface 604 may be, for example, an electromagnetic or active capacitance digitizer interface implemented within touch. screen display 602. As the user writes or draws, processor 608 controls touch screen display 602 to display the writing or drawing input entry on touch screen display 602 with display properties based on the received values of the input parameter according to the transfer function associated with the selected mode.

Implementations of computer device 600 may include implementations of any type of device that may be configured to receive and display writing or drawing input according to the embodiments. For example, computer device 600 may be implemented in a smart phone, a tablet computer, a desktop computer, laptop computer device, gaming devices, media devices, smart televisions, multimedia cable/television boxes, smart phone accessory devices, tablet accessory devices, or personal digital assistants (PDAs). In various implementations, the user interface that receives the mode selection input may be any type of interface such as a touch screen display, a key board, an audio interface, or any other type of interface by which the mode selection may be made. In alternative implementations, certain of the functional blocks shown in FIG. 6 mays be omitted, added to, combined, or rearranged. For example, computer device 600 may be implemented as a number of separate components and devices. For example, computer device 600 may be implemented with an accessory touchpad for use with a computer device where the touchpad receives the writing/drawing input that is displayed on computer device 600. Also, certain of the functional blocks may be modified for operation with input devices having different configurations and capabilities.

Referring now to FIG. 7, therein is a simplified block diagram illustrating an example input device 700. Input device 700 includes pressure sensor 702, touch screen wireless pen interface 704, short range wireless interface 718, processor 706, control inputs 714 and memory 708. Memory 708 may include control programs 712 and pressure sensor control code 710. Control programs 712 may control overall operation of input device 700. Memory 708 may be implemented as any type of computer readable storage media in input device 700, including non-volatile and volatile memory. Processor 706 may comprise one or more processors, or other control circuitry or any combination of processors and control circuitry. Processor 706 provides overall control of input device 700 and the other functional blocks shown in FIG. 7 by executing instructions or code in memory 708 to provide necessary functions for operation of input device 700 according to the disclosed embodiments. Pressure sensor control code 710 may control sensing and digitization of pressure values with which the input device 700 is applied to a surface and the providing of the pressure values to another device such as device 600. In implementations, pressure sensor control code 710 may be part of control programs 712.

In one example implementation, processor 706 may control input device 700 by executing control programs to cause input device 700 to provide an indication of a selection of a mode for the input device made by a user at control inputs 714. For example, a user may set a switch on the control inputs 714 to select a mode, or program a mode selection into input device 700 through control inputs 714. The input device 700 may then communicate the mode selection to a computer device such as the computer device 600 over short range interface 718 which may be, for example, a Bluetooth or Wi-Fi Direct interface, or through touch screen wireless pen interface 704 which may be, for example, an electromagnetic or active capacitance digitizer interface. In this example, the mode would be selected at the input device 700 rather than at the computer device 600. In an alternative example, a mode may be selected by configuring different physical tips on input device 700 to select modes, where each physical tip is associated with a mode that may be sensed or detected by processor 706. Input device 700 may then communicate the mode to a computer device such as computer device 600. In another example the different modes of the physical tips may be detectable by computer device 600 at touch screen display 602.

Input device 700 may then, as a user writes, provide input pressure values measured at pressure sensor 702 to computer device 600 though touch screen wireless pen interface 704. Touch screen wireless pen interface 704 may be configured, for example, to communicate with wireless pen interface 604 that is implemented as an electromagnetic or active capacitance digitizer interface implemented within touch screen display 602.

In various alternative implementations, certain of the functional blocks of input device 700 shown in FIG. 7 may be omitted, added to, combined, modified, or rearranged for operation with devices or computer device having different configurations and capabilities. For example, input device 700 may be implemented as a number of separate components and devices, or with additional functions. In one example implementation, input device 700 may store transfer functions in memory 708 and provide the transfer functions for use by a computer device, such as computer device 600, with which the input device is being used. In another example implementation, input device 700 may use transfer functions stored in memory 708 to determine display properties based on values of input pressure sensed by pressure sensor 702. Input device 700 may then provide the display properties directly to the computer device for display rather than providing the values of input pressure to the computer device.

The example embodiments disclosed herein may be described in the general context of processor-executable code or instructions stored on memory that may comprise one or more computer readable storage media (e.g., tangible non-transitory computer-readable storage media such as memory 612 or 708). As should be readily understood, the terms “computer-readable storage media” or “non-transitory computer-readable media” include the media for storing of data, code and program instructions, such as memory 612 or 708, and do not include portions of the media for storing transitory propagated or modulated data communication signals.

While the functionality disclosed herein has been described by illustrative example using descriptions of the various components and devices of embodiments by referring to functional blocks and processors or processing units, controllers, and memory including instructions and code, the functions and processes of the embodiments may be implemented and performed using any type of processor, circuitry or combinations of processors and/or circuitry and code. This may include, at least in part, one or more hardware logic components. For example, and without limitation, illustrative types of hardware logic components that can be used include field programmable gate arrays (FPGAs), application specific integrated circuits (ASICs), application specific standard products (ASSPs), system-on-a-chip systems (SOCs), complex programmable logic devices (CPLDs), etc. Use of the term processor or processing unit in this disclosure is mean to include all such implementations.

The disclosed embodiments include a computer device comprising a processor and memory in communication with the processor, the memory comprising code, that when executed, causes the processor to control the computer device to receive an indication of a mode corresponding to a type writing/drawing device, determine a transfer function based on the mode, the transfer function defining a display property relative to an input parameter, receive values of the input parameter as associated with an input entry using an input device, determine values for the display property based at least on the transfer function and the values of the input parameter, and display the input entry based on the values of the display property. The transfer function may comprise a non-linear transfer function. The input parameter may comprise pressure and the display property may comprise brush size. The display property may comprise size, opacity, or flow. The input parameter may comprise pressure, an angle or a hover height.

The code further, when executed, may cause the processor to receive an indication of a mode corresponding to a writing/drawing device input device by controlling the computer device to receive an indication of the mode trom a selection of modes at a user interface, and, determine the mode based on the indication. The code may also cause the processor to receive an indication of a mode corresponding to a writing/drawing device by controlling the computer device to detect the mode from a tip of the input device, and, determine the mode for the input device based on the detected mode. Also, the code may further causes the processor to receive an indication of a mode corresponding to an writing/drawing device by controlling the computer device to receive an indication of the mode from a selection of modes at the input device, and, determine the mode for the input device based on the indication. The mode may comprise a selected mode of a plurality of modes, the transfer function may comprise a selected transfer function of a plurality of transfer ftmctions, and the memory may comprise code defining each of the plurality of transfer functions as associated with one of the plurality of modes, and, the code may cause the processor to control the computer device to determine the selected transfer function from the plurality of transfer functions based on the selected mode for the input device

The embodiments also include an input device comprising a processor and a memory in communication with the processor, the memory comprises code that, when executed, causes the processor unit to control the input device to determine a mode for the input device wherein the mode defines a type of drawing device, and, initiate communication of the mode to a computer device configured to receive input from the input device. The code may cause the processor to control the input device to determine the mode for the input device by detecting a mode for a tip configured on the input device. The code may further cause the processor to control the input device to determine the mode for the input device by receiving an indication of the mode for the input device. The code may comprise code defining at least one transfer functions associated with the mode for the input device, the transfer function defining at least one display property relative to an input parameter and the code may cause the processor to control the input device to initiate communication of the at least one transfer function to the device configured to receive input from the input device.

The disclosed embodiments also include a method comprising receiving an indication of a mode corresponding to a type of input device, determining a transfer function based on the mode for the input device, the transfer function defining at least one display property versus an input parameter, receiving values of the input parameter as associated with an input entry using an input device, determining values for the display property based at least on the transfer function and the values of the input parameter, and displaying the input entry based on the values of the display property. The receiving an indication of a mode corresponding to an input device may comprise receiving an indication of the mode for the input device from the input device. The transfer function may be stored in memory on the input device and the determining a value for the display property may comprise sending the value of the at least one display property from the input device to a device configured to receive input from the input device. The input parameter may comprise a pressure or an angle.

Although the subject matter has been described in language specific to structural features and/or methodological operations or acts, it is to be understood that the subject matter defined in the appended claims is not necessarily limited to the specific features, operations, or acts described above. Rather, the specific features, operations, and acts described above are disclosed as example embodiments, implementations, and forms of implementing the claims and these example configurations and arrangements may be changed significantly without departing from the scope of the present disclosure. Moreover, although the example embodiments have been illustrated with reference to particular elements and operations that facilitate the processes, these elements, and operations may or combined with or, be replaced by, any suitable devices, components, architecture or process that achieves the intended functionality of the embodiment. Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A computer device comprising:
a processor; and,
memory in communication with the processor, the memory comprising code, that when executed, causes the processor to control the computer device to:
receive an indication of a mode corresponding to a type of writing/drawing device;
determine a transfer function corresponding to the mode, the transfer function defining a relationship between a display property and an input parameter;
receive values of the input parameter that are associated with an input entry using an input device;
determine values of the display property based at least on the transfer function and the values of the input parameter; and,
display the input entry based on the values of the display property.

2. The computer device of claim 1, wherein the transfer function comprises a non-linear transfer function.

3. The computer device of claim 2, wherein the input parameter comprises pressure and the display property comprises brush size.

4. The computer device of claim 1, wherein the display property comprises brush size.

5. The computer device of claim 1, wherein the display property comprises opacity.

6. The computer device of claim 1, wherein the display property comprises flow.

7. The computer device of claim 1, wherein the input parameter comprises a pressure.

8. The computer device of claim 1, wherein the input parameter comprises an angle.

9. The computer device of claim 1, wherein the input parameter comprises hover height.

10. The computer device of claim 1, wherein the code further causes the processor to receive an indication of a mode corresponding to a type of writing/drawing device by controlling the computer device to receive the indication of the mode from a selection of modes at a user interface.

11. The computer device of claim 1, wherein the code further causes the processor to receive an indication of a mode corresponding to a type of writing/drawing device by controlling the computer device to detect the mode from a tip of the input device.

12. The computer device of claim 1, wherein the code further causes the processor to receive an indication of a mode corresponding to a type of writing/drawing device by controlling the computer device to receive the indication of the mode from a selection of available modes made at the input device.

13. The computer device of claim 1, wherein the mode comprises a selected mode of a plurality of modes, the transfer function comprises a selected transfer function of a plurality of transfer functions, and the memory comprises code defining each of the plurality of transfer functions as associated with one of the plurality of modes and the code causes the processor to control the computer device to:
determine the selected transfer function from the plurality of transfer functions based on the selected mode for the input device.

14. An input device comprising:
a processor; and,
a memory in communication with the processor, the memory comprising code that, when executed, causes the processor to control the input device to:
receive an indication of a mode corresponding to a type of writing/drawing device and,
initiate communication of the mode to a computer device configured to receive input entry from the input device.

15. The input device of claim 14, wherein the code causes the processor to control the input device to receive an indication of a mode corresponding to a type of input device by detecting a mode for a tip configured on the input device.

16. The input device of claim 14, wherein the code causes the processor to control the input device to receive an indication of a mode corresponding to a type of writing/drawing device by receiving the indication of the mode at an input on the input device.

17. The input device of claim 14, wherein the code defines a transfer function associated with the mode for the input device, the transfer function defining at least one display property relative to an input parameter and the code causes the processor to control the input device to initiate communication of the transfer function to the computer device configured to receive input entry from the input device.

18. A method comprising:
receiving an indication of a mode corresponding to a type of writing/drawing device;
determining a transfer function corresponding to the mode, the transfer function defining at least one display property versus an input parameter;
receiving values of the input parameter that are associated with input entry using an input device;
determining values for the display property based at least on the transfer function and the values of the input parameter; and,
displaying the input entry based on the values of the display property.

19. The method of claim 18, wherein the indication of a mode corresponding to a type of writing/drawing device is received from a selection of modes at a user interface.

20. The method of claim 18, wherein the input parameter comprises pressure or an angle.

21. The method of claim 18, wherein the transfer function is stored in a memory on the input device.
